(19) United States
(12) Patent Application Publication
(10) Pub. No.: US 2006/0249958 A1
(43) Pub. Date: Nov. 9, 2006

(54) Rotary latch closure with integrated catch hook function

(76) Inventors: Edvard Ruckert, Velbert (DE); Gerhard Mosch, Duisburg (DE)

Correspondence Address: Martin A. Farber;Suite 473, 866 United Nations Plaza, New York, NY, 10017, US

(21) Appl. No.: 11/267,832

(22) Filed: Nov. 3, 2005

(30) Foreign Application Priority Data
Nov. 4, 2004 (DE) 102004053886.7
Feb. 10, 2005 (DE) 102005006075.7
Nov. 2, 2005 (DE) 102005052836.8

(51) Int. Cl. E05C 5/00

(52) U.S. Cl. 292/110

(57) ABSTRACT

The invention relates to a rotary latch closure with a rotary latch (2) which is mounted on a base plate (1) of a housing or the like in such a way that it can be rotated from a blocking position into a release position and, in the blocking position, uses a fork mouth (5) to keep a locking dog (4) of a mating locking part from being displaced in an opening direction (P2), whereas, in the release position, said locking dog (4) can be displaced in the opening direction (P2). The significant provision is that, when it is displaced between the blocking position and the release position, the rotary latch (2) rotates successively about points of rotation disposed at different locations with respect to the rotary latch.

The invention relates to a rotary latch closure with a rotary latch which is mounted on a base plate of a housing or the like in such a way that it can be rotated from a blocking position into a release position and, in the blocking position, uses a fork mouth to keep a locking dog of a mating locking part from being displaced in an opening direction, whereas, in the release position, said locking dog can be displaced for displacement in the opening direction.

Rotary latches of the aforementioned types are known in the prior art. They are used for example for the closures of engine hoods on motor vehicles. With this rotary latch, which is disposed in the front end of a motor vehicle, a mating locking part that is in the form of a locking dog and is secured to an engine hood is held. By pivoting the rotary latch, the locking dog held in the blocking position by the fork mouth is released in such a way that it can be displaced in the opening direction. This displacement is accompanied by the engine hood being opened by a gap. In the case of the known rotary latch closure, the rotary actuation of the rotary latch in the opening direction takes place by means of a tension or compression spring. The rotary latch is held in the blocking position by a catch. After releasing the catch, the rotary latch is automatically pivoted in the opening direction. The engine hood is held in the gap position by a catch hook. This must be pivoted back by a second actuation to allow the engine hood to be finally opened.

The invention is based on the object of developing a rotary latch closure of the generic type in a functionally advantageous way.

The object is achieved by the invention specified in the claims, each claim describing and claiming an essentially independent solution and it being possible for any claim to be combined with any other claim.

Claim 1 provides first and foremost that, when it is displaced between the blocking position and the release position, the rotary latch rotates successively about points of rotation disposed at different locations with respect to the rotary latch. According to the invention, the rotary latch does not rotate about a fixed point of rotation, but rotates about different points of rotation during its opening and closing movement, it being possible for these points of rotation to be associated with a pivot pin that is fixed to the housing, but lying at different locations with respect to the rotary latch itself. Between the at least two different pivoted positions, the rotary latch can be displaced in a linear manner about the different points of rotation. The rotary latch formed in this way may be intended for a bottom locking mechanism or a rear locking mechanism on a motor vehicle seat. Furthermore, it may be provided that, as result of the different rotational movements, the rotary latch not only performs a locking function but also a catching function, for example if it is used as a front flap closure. In particular, it is provided that, starting from the blocking position, the rotary latch can be pivoted by way of a first pivoting displacement, initially in a stop-limited manner, into an intermediate position, in which the locking dog held by the fork mouth can be displaced in the opening direction part of the way into a catching position, from which catching position the locking dog can be released by a second pivoting actuation of the rotary latch into its release position. In a preferred refinement of the invention, the rotary latch has a guiding slot. This guiding slot extends substantially transversely in relation to the path followed by the fork mouth, which follows the line of an arc of a circle. At its end remote from the fork mouth, the guiding slot forms a latching recess. Between its other end, near the fork mouth, and said latching recess, the guiding slot has a second latching recess, running obliquely in the direction of the opening of the fork mouth. Disposed within the guiding slot are pins. There are a total of two latching/guiding pins, which are fixed to the housing and pass through the guiding slot. In a locking position, the second latching pin lies in the latching recess running obliquely in the direction of the fork mouth. In the course of the first pivoting displacement of the fork rotary latch, which takes place against the restoring force of a spring, this second latching pin leaves its associated latching recess. The rotary latch then pivots into an intermediate position. From this intermediate position, the rotary latch is displaced by the spring into a catching position. In this linear displacement, the pins slide through the guiding slot. While the first latching pin performs the function of a pivot pin in the locking position, and thereby lies in the region of the end of the guiding slot, the second pin assumes the function of a stop pin in the catching position, when it strikes against the other end of the guiding slot, in order to end its linear displacement. Associated with the second pin is the second recess already mentioned above, which is an escape recess. The pin can enter this escape recess when the rotary latch carries out its second pivoting displacement, which likewise takes place against the restoring force of the spring. In this pivoting displacement too, the first pin has the function of a bearing pin. It then lies between the escape recess and the aforementioned latching recess. In the locking position, the locking dog is held in an end portion of the fork mouth. As a result of the pivoting of the rotary latch during its displacement from the blocking position into the catching position, the locking dog moves into a central portion of the fork mouth. The locking dog thereby also carries out a linear displacement. It is displaced by the fork rotary latch away from the lock housing, and in particular out of a capturing slot associated with the lock housing. A preferred application of the rotary latch closure is an engine hood closure on a motor vehicle. The lock housing or the base plate is in this case secured at the front end of the vehicle body. The mating locking part and its locking dog are located on the engine hood. During the displacement of the rotary latch from the blocking position into its catching position, the locking dog is raised as a result of the linear displacement of the rotary latch. This is accompanied by the engine hood going into a position in which it is open with a gap. It is possible to reach through this gap for manual engagement at a release point or a release connected to the release point, in order to carry out the second pivoting movement of the rotary latch, within which the locking dog is completely released, so that the engine hood can be opened. If the engine hood is closed again, the locking dog acts against a sloping flank of the rotary latch associated with the fork mouth. The sliding of the locking dog on the sloping flank leads to a pivoting movement of the rotary latch and to the capture of the locking dog in the fork mouth. Further linear loading, for example downward loading of the engine hood, leads to actuation of the rotary latch from the catching position into the intermediate position described above. The engine hood is thereby closed completely. When the aforementioned intermediate position is reached, the second pin lies opposite the latching recess. The force of the spring makes the rotary latch rotate into the blocking position, the second pin entering the latching recess. In a variant of the invention, it is provided that at least one pivoting movement of the rotary latch takes place about the locking dog. The guiding slot, through which a guiding pin which forms the physical axis of rotation of the rotary latch passes, may have an angular shape, the angle concerned being an obtuse angle. The guiding slot consequently forms two recesses. One of the two recesses may form a clamping shoulder. The guiding pin is released by this clamping shoulder when the rotary latch is pivoted out of the blocking position. The rotary latch thereby pivots about the locking dog. The clamping shoulder runs on an eccentric line, in particular a line in the form of a rotating wedge or spiral, about the position of the locking dog which the latter assumes in the blocking position. If the guiding pin leaves the clamping shoulder, it can enter the other recess of the guiding slot. Accompanying this, the rotary latch can be linearly displaced slightly. In a further phase of the opening movement of this rotary latch, it rotates about the guiding pin. The locking dog thereby leaves the fork mouth of the rotary latch, where it is held with positive engagement. The rotary latch has a control pin, which engages in a control slot of the housing. This control slot is operatively identical to the stops described above which define the sequence of movements of the rotary latch. In the closing actuation, the locking dog first enters a capturing slot of the base plate, where it acts upon a shoulder of a fork mouth of the rotary latch. During this actuation, the control pin leaves a holding recess of the control slot. This movement corresponds to a linear displacement of the rotary latch. The actuation of the leg of the fork mouth is accompanied by release of the rotational displacement of the rotary latch. The rotary latch is displaced by a tension spring. In the course of this pivoting movement, which corresponds in the terminology of the above description to the second pivoting movement, the locking dog is engaged by the fork mouth. The rotary latch thereby rotates about an axis of rotation, which corresponds substantially to the position of the guiding pin. This rotational movement may be superposed by a lateral movement of the rotary latch. The complex rotational movement of the rotary latch when the locking dog is captured is determined by the curve of the control recess. During this capturing movement, the guiding pin is displaced in a first recess of the guiding slot, until it has reached the apex point of the two recesses of the guiding slot. Then, the guiding pin runs along on the clamping shoulder, so that loading occurs. The rotary latch thereby rotates about the locking dog. At the same time, the locking dog is drawn against the end of the capturing slot.

Exemplary embodiments of the invention are explained below on the basis of accompanying drawings, in which:

FIG. 1 shows a closure in a locking position in schematic representation,

FIG. 2 shows the closure in an intermediate position, which is reached by pivoting the rotary latch through a first pivoting angle,

FIG. 3 shows the closure in the catching position, which is reached by linear displacement of the rotary latch from the intermediate position represented in FIG. 2,

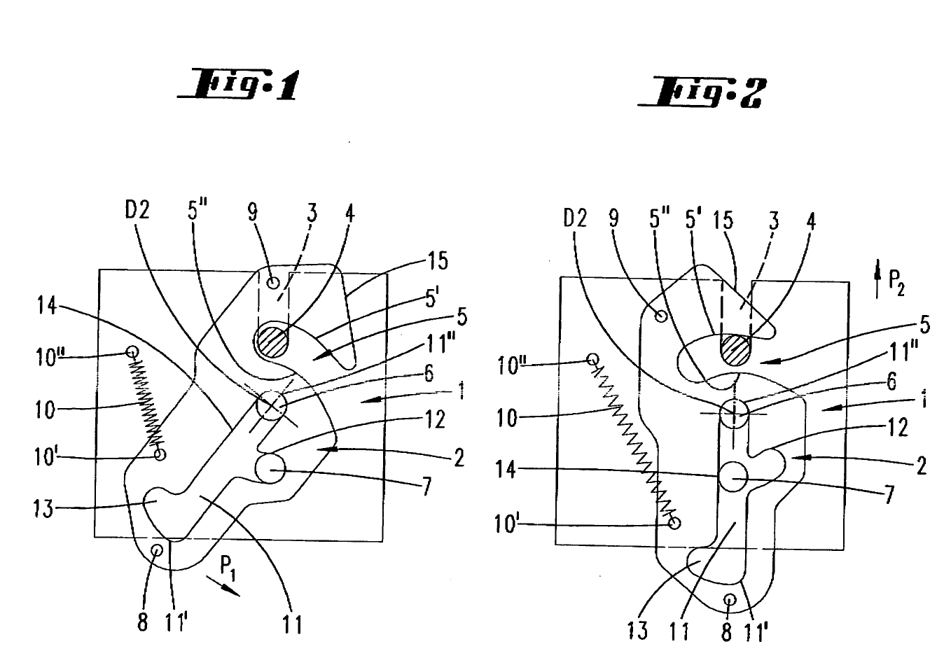

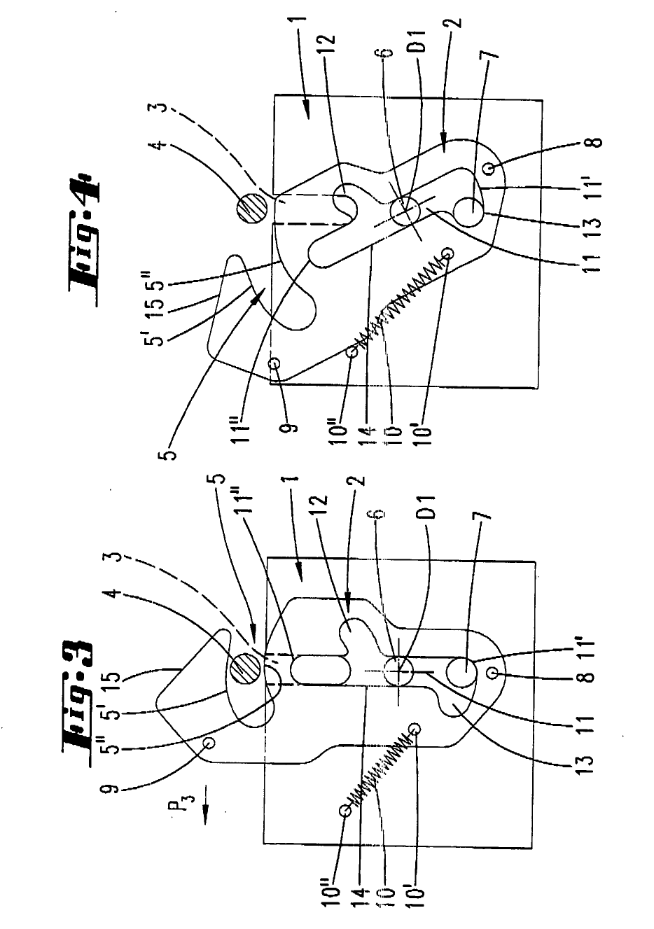

FIG. 4 shows a release position, which can be reached by a second displacement of the rotary latch from the catching position represented in FIG. 3,

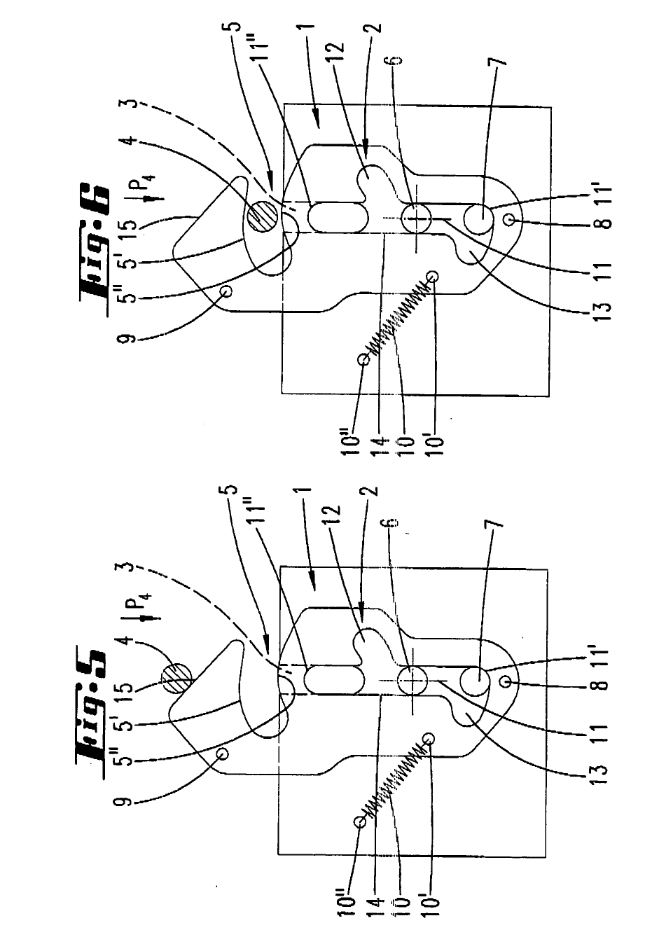

FIG. 5 shows the capture readiness position of the rotary latch, with a locking dog sliding on a sloping flank 15,

FIG. 6 shows a follow-up representation to FIG. 5 with the locking dog captured,

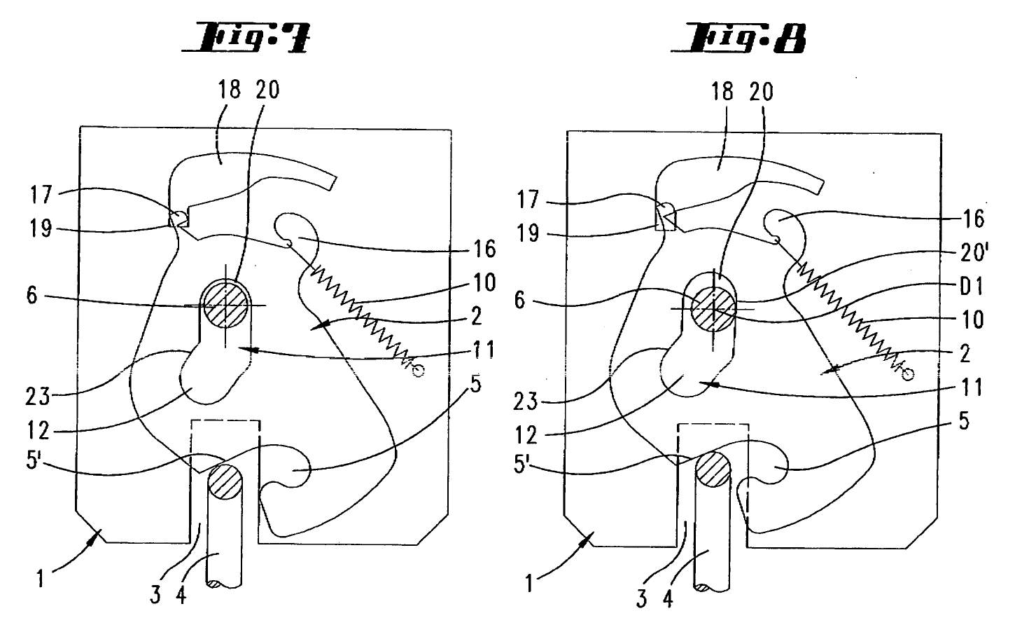

FIG. 7 shows a representation of a further exemplary embodiment of the invention in a capturing position for a locking dog,

FIG. 8 shows a follow-up representation, the locking dog being supported on a wall of the fork slot of the rotary latch,

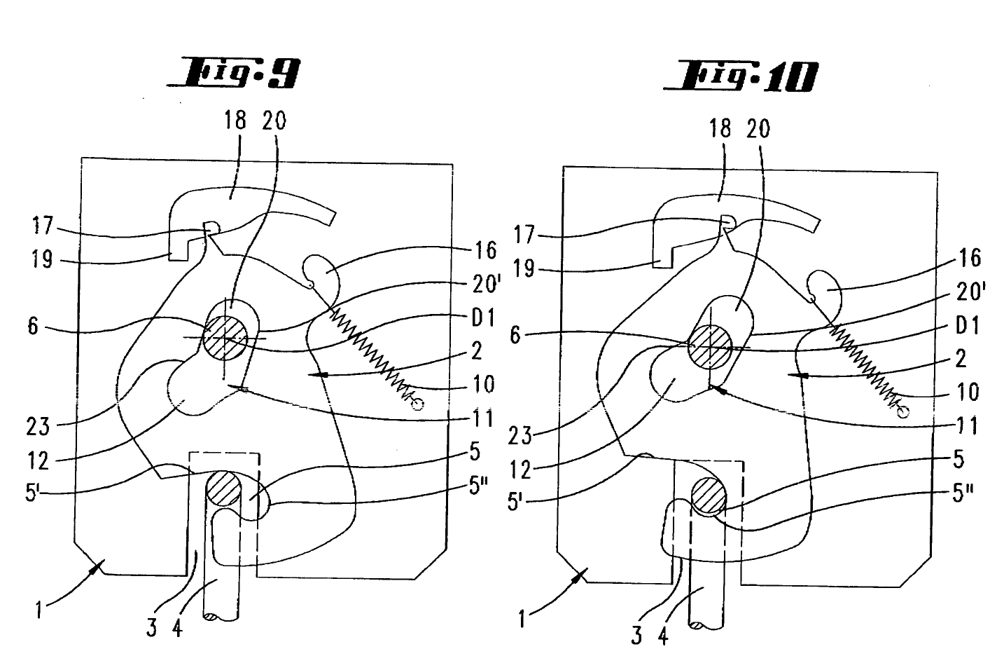

FIG. 9 shows a follow-up representation, the rotary 10 latch being pivoted about its first axis of rotation,

FIG. 10 shows a follow-up representation, the first pivoting movement of the rotary latch being complete,

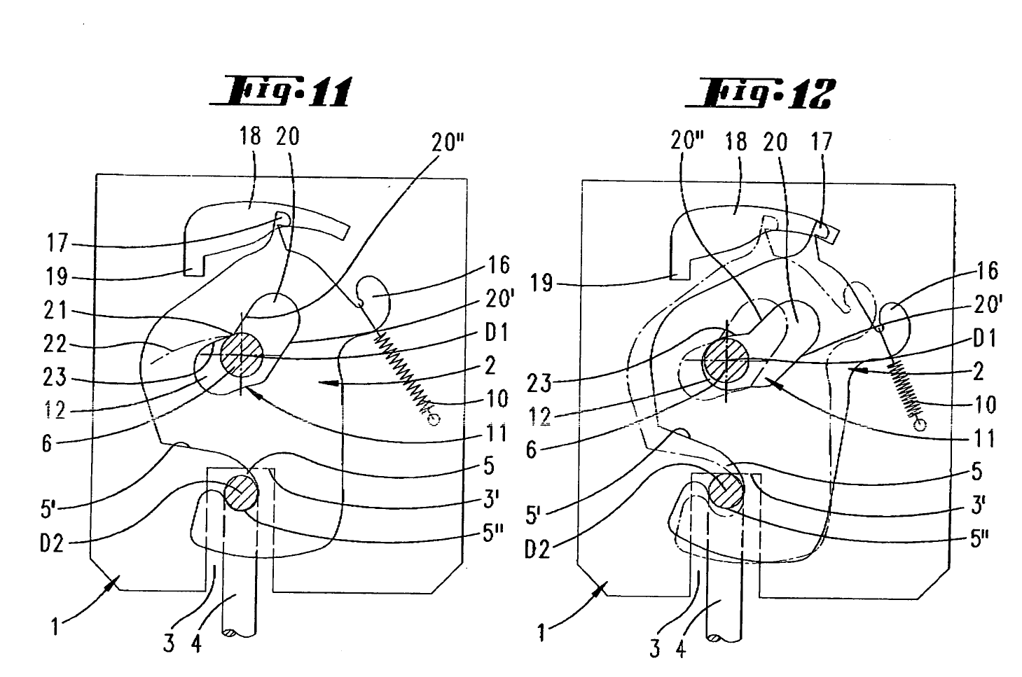

FIG. 11 shows a further follow-up representation, the rotary latch having been linearly displaced slightly and

FIG. 12 shows a follow-up representation, the rotary latch having performed a second rotational movement about the locking dog.

The closure represented in the drawings substantially comprises a rotary latch 2 made of metal, which rests on a base plate 1 of a housing. The housing has a capturing slot 3 for a locking dog 4 of a mating locking part (not represented) . The closure may be disposed at a front end of a motor vehicle. The associated mating locking part may be associated with the free end of an engine hood, so that the engine hood is held by the closure in the closed position in such a way that the locking dog 4 is held in a fork mouth 5 of the rotary latch 2.

However, the closure may also be used in a different way.

The rotary latch 2 has an elongate guiding slot 11, which at its first end 11″ forms a rotary bearing for a first pin, which is fixed to the housing and is referred to as guiding pin 6. The end 11′ of the guiding slot 11 that is opposite from this end 11″ forms a stop for a second pin, which is secured to the base plate 1 and is referred to as the latching pin 7. In the region of this end 11′, the guiding slot 11 continues into an escape recess 13.

Between the two ends 11′ and 11″ there is a latching recess 12, which lies opposite and offset from the escape recess 13. The distance between the latching recess 12 and the end 11″ corresponds to the distance between the guiding pin 6 and the latching pin 7. The latching pin 7 and the guiding pin 6 lie in line with the opening direction of the capturing slot 3.

The rotary latch 2 has a substantially arcuate slot, which is open at the edge and forms the fork mouth 5.

In the blocking position represented in FIG. 1, the rotary latch 2 is held by a tension spring 10, which acts on the rotary latch 2 at the location identified by 10′ and acts on the base plate 1 at the location identified by 10″.

The reference numeral 8 designates a first release point, at which the rotary latch can be pivoted out of the locking position represented in FIG. 1 into the pivoted position represented in FIG. 2. This takes place by exerting a pull in the direction of the arrow P1, the rotary latch 2 being pivoted about the guiding pin 6, which lies in the end region 11″ of the guiding slot 11.

On the head side, the rotary latch 2 has a sloping flank 15, which performs the function of a running-on slope for the locking dog 4 when the closure is to be closed. Lying opposite the sloping flank 15 is a second release point 9. Starting from the catching position represented in FIG. 3, a tensile force can act on this release 9 in the direction P3, in order to pivot the rotary latch 2 into the release position.

Both pivoting movements P1 and P3 take place against the restoring force of one and the same tension spring 10. This tension spring 10 is also capable of displacing the rotary latch in the direction of the arrow P2 from the intermediate position represented in FIG. 2 into the catching position represented in FIG. 3.

The closure operates as follows:

In the locking position, represented in FIG. 1, the rotary latch 2 is held by the force of the tension spring 10. In this locking position, the locking dog 4 lies in the capturing slot 3 of the base plate 1 and is held there by the fork mouth 5 of the rotary latch 2. The locking dog 4 lies approximately in the end region of the fork mouth 5.

In this locking position, the rotary latch 2 cannot be displaced in the direction of the arrow designated by P2 in FIG. 2, since the latching pin 7 fixedly connected to the housing 1 is engaged in the latching recess 12. It thereby lies against a latching shoulder formed by the wall of the latching recess 12.

If the rotary latch 2 is pivoted out of the latching position represented in FIG. 1 by a pull in the direction of the arrow P1 on the release 8, the rotary latch 2 rotates about the guiding pin 6, which is located in the end region 11″ of the guiding slot 11. The latching pin 7 thereby leaves its associated latching recess 12, so that the intermediate position represented in FIG. 2 is reached.

The intermediate position represented in FIG. 2 is reached when the latching pin 7 enters the guiding slot 11, or makes contact with the stop 14 formed by the wall of the guiding slot 11. In the intermediate position, the locking dog 4 continues to be in the region of the fork mouth 5. It is therefore held by the fork mouth 5. For this purpose, the fork mouth 5 forms a holding shoulder 5′. Lying opposite the holding shoulder 5′ is an opposed shoulder 5″.

When the intermediate position represented in FIG. 2 is reached, the tension spring 10 can displace the rotary latch 2 linearly into the catching position represented in FIG. 3. During this displacement, the rotary latch 2 is guided by the guiding slot 11, in which the guiding pin 6 and the latching pin 7 slide along. The linear displacement is complete when the latching pin 7 strikes against the end 11′ of the slot 11.

In the course of the displacement from the intermediate position into the catching position, the locking dog is displaced part of the way in the direction of its opening direction P2. The locking dog 4 is thereby acted upon by the flank 5″.

In the catching position represented in FIG. 3, the locking dog 7 lies in the region of the escape recess 13. The guiding pin 6 lies between the latching recess 12 and the escape recess 13.

By acting on the release 9 and exerting a pull in the direction of the arrow P3, the rotary latch 2 can be pivoted through a further pivoting angle in the same pivoting direction against the restoring force of the spring 10. The latching pin 7 thereby enters the escape recess 13 and the guiding pin 6 acts in the same way as in the first pivoting displacement of the rotary latch 2 as a pivot pin.

On completion of the second pivoting displacement, which is represented in FIG. 4, the release position is reached, in which the locking dog 4 can leave the closure, so that for example an engine hood can be opened completely from the position in which it is open with a gap, represented in FIG. 3.

If a pull is no longer applied to the release point 9, the spring 10 pivots the rotary latch back into the capture readiness position represented in FIG. 5.

If, in this pivoted position, which corresponds to the catching position represented in FIG. 3, the engine hood is closed, the locking dog 4 makes contact with the sloping flank 15 of the rotary latch 2. The torque which is thereby exerted pivots the rotary latch 2 in the direction of its release position, represented in FIG. 4, so that the locking dog 4 sliding on the sloping flank 15 can enter the fork mouth 5. The capturing position represented in FIG. 6 is then reached.

Pressure in the direction of the arrow P4 has the effect that the locking dog 4 acts upon the opposed shoulder 5′ of the fork mouth 5. The holding force of the spring 10 can in this case be overcome. As a consequence of this, the rotary latch 2 is displaced back in the linear direction, until the intermediate position represented in FIG. 2 is reached, since in this position no force acts on the release point 8, the latching pin 7 can enter its associated latching recess 12, which is assisted by the tensile force of the tension spring 10. The locking position of the closure is then reached.

The spring 10 is dimensioned in such a way that, when the closure is used as a hood closure, it displaces the engine hood up out of the intermediate position into the catching position and holds it there.

In the course of the closing movement of this previously described rotary latch, it always rotates about the guiding pin 6, but at different points of rotation D1, D2 with respect to the rotary latch 2, to be specific about the end 11″ of the guiding slot 11 that is near the fork mouth 5 from the position represented in FIG. 1 into the position represented in FIG. 2, and about the point of rotation D1, which is further away from the fork mouth 5 than the point of rotation D2, in the rotation from the position represented in FIG. 3 into the position represented in FIG. 4.

FIGS. 7 to 12 show a second exemplary embodiment of the invention, in which the rotational movement or the linear movement of the rotary latch 2 with respect to the base plate 1 is controlled by a single guiding pin 6, which lies in a guiding slot 11. Instead of stops, provided here is a control slot 18, in which a control pin 17 of the rotary latch 2 engages. This control slot 18 has a holding recess 19, in which the control pin 17 engages in the open position of the rotary latch 2 represented in FIG. 7. In this position, the rotary latch 2 is ready for capturing a locking dog 4, which is captured by a capturing slot 3 of the base plate 1.

The rotary latch 2 has an angular guiding slot 11. The guiding slot 11 has a first recess 20, in which the guiding pin 6 rests in the open position of the rotary latch 2. In this operating position, this guiding slot 20 points toward the capturing slot 3 and goes over at an obtuse angle into a latching recess 12.

A somewhat longer leg of the fork mouth 5 of the rotary latch 2 forms a stop shoulder 5′, against which the locking dog 4 acts when it enters the capturing slot 3. The locking dog 4 thereby transmits a force to the rotary latch 2, which is spring-biased into its closed position by a rotary latch spring 10. This force acting upon the locking dog 4 has the effect that the rotary latch 2 is linearly displaced in such a way that its control pin 17 leaves the holding recess 19. The recess 20 is of a length required for the linear displacement, so that the guiding pin 6 can move linearly in it until the operating position represented in FIG. 8 is reached.

In this operating position, the control pin 17 has left the holding recess 19, so that the spring 10 can exert a rotational movement on the rotary latch. The rotary latch then rotates about the point of rotation D1. The physical axis of rotation is the guiding pin 6, which lies in a central region of the recess 20. During the rotational movement from the position represented in FIG. 8 into the position represented in FIG. 10, the guiding pin 6 additionally moves linearly in the recess 20 slightly, with the result that the overall movement of the rotary latch 2 is complex. This phase of the rotary latch movement is complete when the locking dog 4 lies completely in the fork mouth 5. It is then accommodated by a rounded pocket 5″, which forms the end of the fork mouth 5.

Starting from the operating position represented in FIG. 10, the spring 10 acting on it causes the rotary latch to rotate about the point of rotation designated by D2, which is associated with the locking dog 4 or the pocket 5″ of the fork mouth 5.

With the reference numeral 22, an arcuate line about the point D2 is represented by dashed-dotted lines, The wall of the latching recess 12 designated by the reference numeral 23 lies on an eccentric line or on a spiral line about the point D2.

In the operating position represented in FIG. 11, the guiding pin 6 lies on the point of intersection 21 of the wall 20″ of the recess 20 and the clamping shoulder 23, which is formed by a wall of the latching recess 12. The force of the spring 10 now acts with the effect that a pulling force is exerted on the locking dog 4 when the guiding pin 6 slides along on the clamping shoulder 23. This has the effect that the locking dog 4 is drawn into a stop position against the base 3′″ of the capturing slot 3. It lies there in a loaded position, which is maintained by the force of the spring 10. This position does not have to be a self-locking position.

All disclosed features are (in themselves) pertinent to the invention. The disclosure content of the associated/attached priority documents (copy of the prior patent application) is also hereby incorporated in full in the disclosure of the application, including for the purpose of incorporating features of these documents in claims of the present application.

We claim:

1-24. (canceled)

25. Rotary latch closure comprising a base plate of a housing with a rotary latch (2) mounted on the base plate (1) of the housing, the latch being rotatable from a blocking position into a release position; wherein, in the blocking position, a fork mouth (5) of the latch serves to keep a locking dog (4) of a mating locking part of the latch closure from being displaced in an opening direction (P2), whereas, in the release position, said locking dog (4) is displaceable in the opening direction (P2); wherein upon displacement between the blocking position and the release position, the rotary latch (2) rotates successively about points of rotation disposed at different locations with respect to the rotary latch.

26. Rotary latch closure as claimed in claim 25, wherein, starting from the blocking position, the rotary latch (2) can be pivoted by way of a first pivoting displacement (P1), initially in a stop-limited manner, into an intermediate position; wherein, in the intermediate position, the locking dog (4) held by the fork mouth (5) can be displaced in the opening direction part of the way into a catching position; wherein, from the catching position the locking dog (4) can be released by a second pivoting movement (P3) of the rotary latch (2) into its release position for further displacement in the opening direction (P2).

27. Rotary latch closure as claimed in claim 25, wherein the rotary latch (2) is linearly displaceable with respect to the base plate (1) between two pivoting movements about points of rotation disposed at different locations with respect to the rotary latch.

28. Rotary latch closure as claimed in claim 25, further comprising a first guiding pin (6) that passes through a guiding slot (11) of the rotary latch (2) to form an axis of rotation for at least one pivoting movement.

29. Rotary latch closure as claimed in claim 28, wherein the guiding slot (11) associated with the rotary latch (2), through which there passes the first guiding pin (6), fixed to the housing, and a second pin (7), fixed to the housing.

30. Rotary latch closure as claimed in claim 29, wherein, in the locking position, the second pin (7) lies in a latching recess (12).

31. Rotary latch closure as claimed in claim 30, wherein, in the course of the first pivoting displacement, the second pin (7) leaves its associated latching recess (12).

32. Rotary latch closure as claimed in claim 20, wherein the rotary latch (2) is held in the locking position by a spring (10).

33. Rotary latch closure as claimed in claim 32, wherein the rotary latch (2) can be displaced from the locking position into the intermediate position against the restoring force of the spring (10).

34. Rotary latch closure as claimed in claim 26, wherein the latch has a guiding slot (11) and the rotary latch (2) can be linearly displaced from the intermediate position into the catching position by the force of a spring (10), one pin (6) and a second pin (7), which are mounted to the housing, sliding along in the guiding slot (11).

35. Rotary latch closure as claimed in claim 34, wherein, in the catching position, the second pin (7) strikes against a stop (11′), which is formed by the end of the guiding slot (11).

36. Rotary latch closure as claimed in claim 24, wherein the guiding slot (11) has an escape recess (13), which is functionally associated with the latching pin (7) and which escape recess (13) is entered by the second pin (7) during a second pivoting displacement from the catching position into the release position.

37. Rotary latch closure as claimed in claim 36, wherein the second pivoting displacement takes place against the restoring force of the spring (10).

38. Rotary latch closure as claimed in claim 26, wherein the locking dog (4) is held in the catching position by a central portion (5′) of the fork mouth (5).

39. Rotary latch closure as claimed in claim 26, wherein an opposed shoulder (5″) of the fork mouth (5) linearly raises the locking dog from the intermediate position into the catching position.

40. Rotary latch closure according to claim 26, wherein the latch has a sloping flank (15) running at an acute angle to the bent fork mouth (5), for a controlled return of the rotary latch (2) to capture the locking dog (4).

41. Rotary latch closure as claimed in claim 26, wherein the rotary latch (2) can be displaced back from the catching position into the blocking position by being acted upon by the locking dog (4).

42. Rotary latch closure as claimed in claim 26, wherein a guiding pin (6) is mounted to the housing, and the two pivoting movements (P2, P3) take place about the same guiding pin (6).

43. Rotary latch closure as claimed in claim 26, wherein a first pivoting movement of the latch takes place about the locking dog (4), while the guiding pin (6) slides along a clamping shoulder (23) of the latch.

44. Rotary latch closure as claimed in claim 25, wherein a guiding slot (11) of the latch forms two recesses (12, 20) at an obtuse angle in relation to each other.

45. Rotary latch closure as claimed in claim 44, wherein a latching recess (12) of the obtuse-angled guiding slot (11) forms a clamping shoulder (23).

46. Rotary latch closure as claimed in claim 25, wherein the latch (2) has a control pin (17), which is guided in a control slot (18) on the housing.

47. Rotary latch closure as claimed in claim 26, wherein the second pivoting movement of the rotary latch (2) is a capturing movement of the locking dog (4), and the first pivoting movement of the rotary latch (2) brings about loading of the locking dog (4) with respect to the rotary latch closure.

48. Rotary latch closure as claimed in claim 26, wherein the second pivoting movement of the rotary latch (2) is superposed by a linear movement component of the rotary latch (2) with respect to the base plate (1).
